(19) United States
(12) Patent Application Publication
(10) Pub. No.: US 2003/0149609 A1
(43) Pub. Date: Aug. 7, 2003

(54) Future event service rendering method and apparatus

(75) Inventor: Tomomi Kasahara, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/200,737

(22) Filed: Jul. 24, 2002

(30) Foreign Application Priority Data
Feb. 6, 2002 (JP) 2002-028967

(51) Int. Cl. G06F 17/60

(52) U.S. Cl. 705/9

(57) ABSTRACT

A service center stores the contents of a request in a request master based on the request from a user. A server of the service center checks the contents of the request master depending on need, and determines whether or not a condition for rendering a transmission service to a recipient is satisfied based on a request. Examples of contents of a requested service include marriage, baby delivery, etc. Whether or not these events occur is determined by searching a people information master possessed by an electronic government.

### BACKGROUND OF THE INVENTION

1. Field of the Invention

The present invention relates to a system and method reserving a service of an event that can possibly occur in the future.

2. Description of the Related Art

Conventionally, congratulatory and condolence messages or objects in the case of marriage, baby delivery, a funeral service, etc. were transmitted by mail, etc. by a person who desires to transmit a message or an object to a person who has an event such as marriage, etc. after he or she receives a notification of the event.

In this case, however, a person who desires to transmit a message, etc. must learn the fact that a person has experienced an event, the transmission destination, the transmission date and time, etc. of the person who has experienced the event.

Namely, a person who desires to transmit a message, etc. can transmit a message, etc. only after a transmitter, a recipient, and an event occurred for the recipient are proved to exist.

For example, if something is transmitted by mail, it cannot be transmitted unless a recipient exists. Additionally, although an approximate date can be specified, a transmission cannot be automatically made at the timing when a certain event occurs.

Assume the existence of a grandchild who is loved very much by a grandmother. Even if the grandmother desires to give some present when the grandchild gets married, whether or not she is alive at that time is unclear. It is more convenient to be able to receive a postal service by which a predetermined object is delivered when the grandchild gets married, while she is alive.

### SUMMARY OF THE INVENTION

An object of the present invention is to provide an apparatus and method that reserve a service for a future event, and render the reserved service when the event occurs.

The method according to the present invention comprises: receiving from a user identification information of an event, a date and time when the event occurs, information of a medium transmitted when the event occurs, and transmission destination information of the medium; and extracting whereabouts of a person who is associated with the event, when an occurrence of the event received from the user is detected based on a first storing unit storing the identification information of the event, the date and time when the event occurs, and information of whereabouts of the person who is associated with the event, and a second storing unit storing the information received from the user.

According to the present invention, a medium transmission can be reserved by specifying beforehand an event that occurs for a counterpart to whom a medium (actual stuff, an electronic document, cash, etc.) is desired to be transmitted. Accordingly, a grandmother can transmit a monetary gift beforehand to a grandchild as a wedding gift of the grandchild, even after the grandmother herself was died.

Furthermore, since a medium is transmitted to a counterpart after a predetermined term elapses, this method can be also used like a time capsule.

### BRIEF DESCRIPTION OF THE DRAWINGS

FIG. 1 shows the entire configuration of a system according to a preferred embodiment of the present invention;

FIGS. 2A and 2B are flowcharts (No. 1) explaining the flows of processes according the preferred embodiment of the present invention;

FIGS. 3A and 3B are flowcharts (No. 2) explaining the flows of processes according to the preferred embodiment of the present invention;

FIG. 4 is a flowchart (No. 3) explaining the flow of the process according to the preferred embodiment of the present invention;

FIGS. 5A to 5E exemplify data tables used by the processes according to the preferred embodiment;

FIGS. 6A to 6C exemplify data tables for explaining specific processes;

FIGS. 7A to 7C exemplify displays (No. 1) according to the preferred embodiment of the present invention;

FIGS. 8A to 8D exemplify displays (No. 2) according to the preferred embodiment of the present invention; and

FIG. 9 shows the hardware environment required when the preferred embodiment according to the present invention is implemented with a program.

### DESCRIPTION OF THE PREFERRED EMBODIMENTS

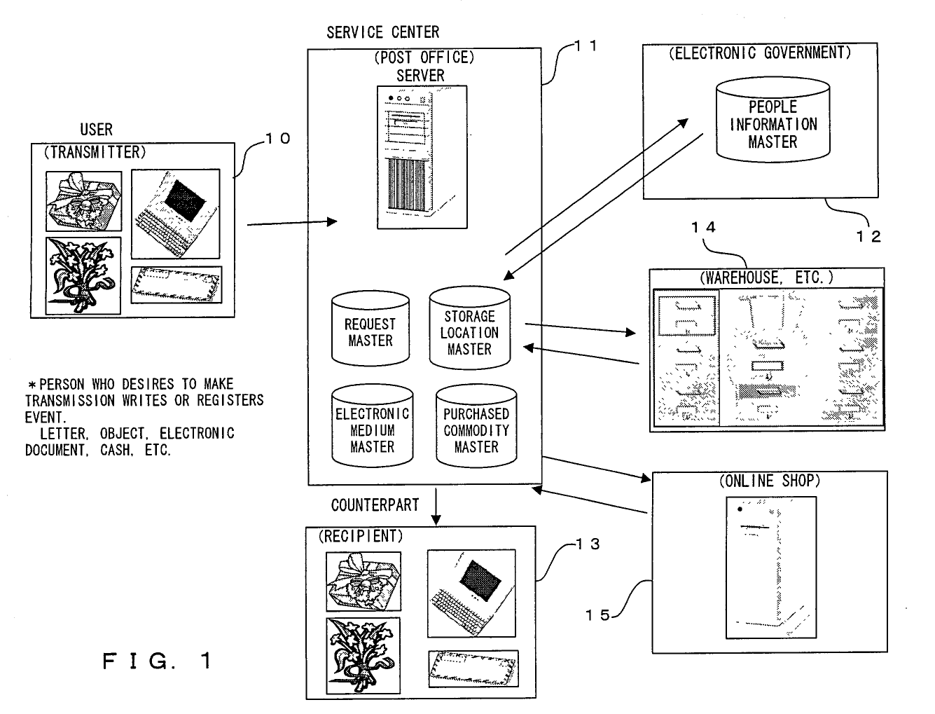

FIG. 1 shows the entire configuration of a system according to a preferred embodiment of the present invention.

A user 10 who desires to receive a service according to this preferred embodiment accesses a server of a service center 11 (such as a post office) with a terminal via the Internet and registers service reservation. Or, the user 10 carries an object to be transmitted to a counterpart (recipient) 13, goes to the service center 11, and registers a service reservation when receiving the service. Examples of the object to be transmitted to the recipient 13 when the user 10 receives the service include a variety of items such as a letter, a commodity, an electronic document, cash, etc. When an electronic document is transmitted, only operation that the user 10 must perform is to connect his or her terminal to the service center 11 via the Internet, or the like, and to input the contents of an event, a recipient, and the contents of the electronic document from the terminal.

Additionally, the user 10 can register a reservation of a service by which the user 10 carries an object to be transmitted to a recipient to the service center 11 at some future date after specifying the contents of an event, the status of the user 10, and a recipient from the terminal connected to the service center 11.

In the service center 11, the contents of the service reservation registration requested from the user 10 are held in a request master, and a condition specified by the user 10, for example, an occurrence of a predetermined event for the recipient 13 is monitored by accessing a people information master possessed by an electronic government 12.

The service center 11 monitors the people information master of the electronic government 12. When an event such as marriage, etc., which is specified by the user 10, occurs for the recipient 13, the object to be transmitted such as a letter, an electronic document, a commodity, cash, etc., which is requested by the user 10, is transmitted to the recipient 13. Note that an electronic document can be transmitted by e-mail or by telegram. Additionally, an electronic document can be printed as a letter in a predetermined format, and transmitted as mail. Furthermore, if an object to be transmitted is actual stuff such as a letter, a commodity, etc., it is transmitted to the recipient 13 by mail. Furthermore, if the object to be transmitted is cash, it may be transmitted as registered mail for cash. However, if a financial institute such as a bank, etc. joins the service according to this preferred embodiment, cash can be transferred to an account of the recipient 13 via an account of the financial institute.

Warehouse, etc. 14 is a location in which a medium received from a requester is held after the service center 11 accepts a request (?). When a specified event occurs, the medium is extracted from the warehouse, etc. 14, and transmitted to a transmission destination.

Additionally, an online shop 15 is used when a requester purchases a commodity as a medium when transmitting the medium to a transmission destination. For example, an object such as a bouquet, a book, etc., which is handled by the online shop 15, can be purchased by a requester online via the service center 11, and used as a medium to be transmitted to a transmission destination when the service center 11 renders a service.

A preferred embodiment is described below by assuming that the service center is a post office.

The user (transmitter) 10 specifies a recipient 13 and an event, and makes a request to the post office. The post office side registers this request to a database, and monitors the event in cooperation with the electronic government. For example, if a grandmother desires to give a present to a grandchild, the following procedure is performed.

recipient: the name of the grandchild

event: marriage

The post office transmits the present to the specified address when a marriage notification of the grandchild is submitted.

Following is an example of the case where a person whose rest of life is short transmits a letter to an unborn baby of his or her daughter.

recipient: child of his or her daughter

event: birth registration

Or, an unmarried person can write a letter to a future spouse (recipient: wedding partner, event: marriage notification)

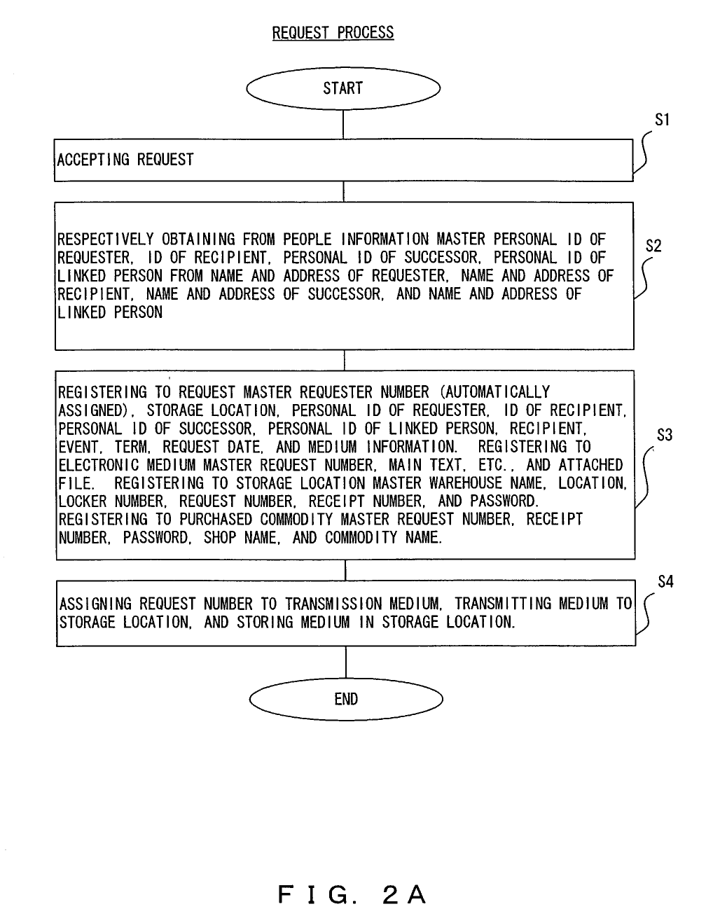

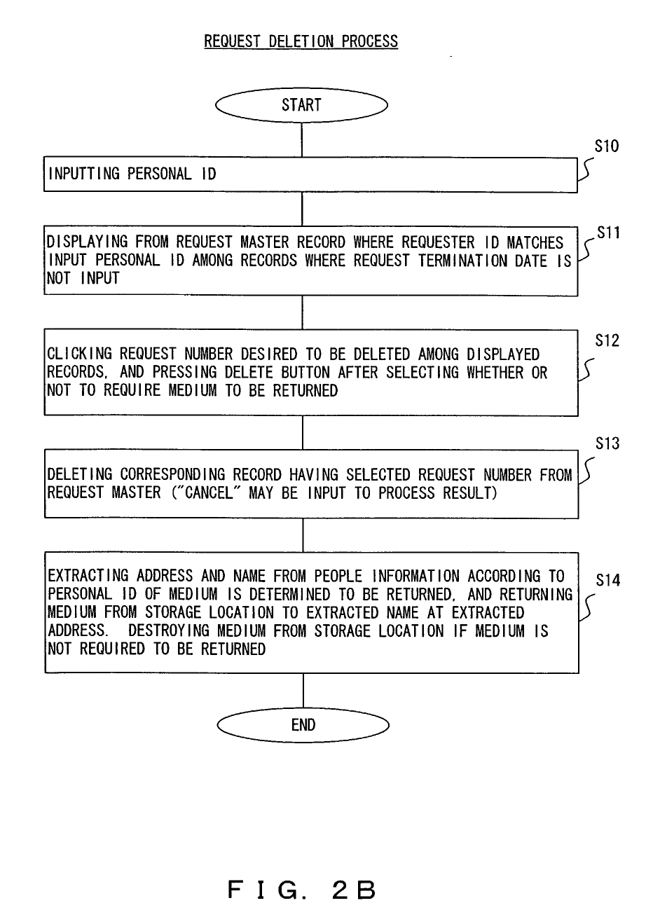

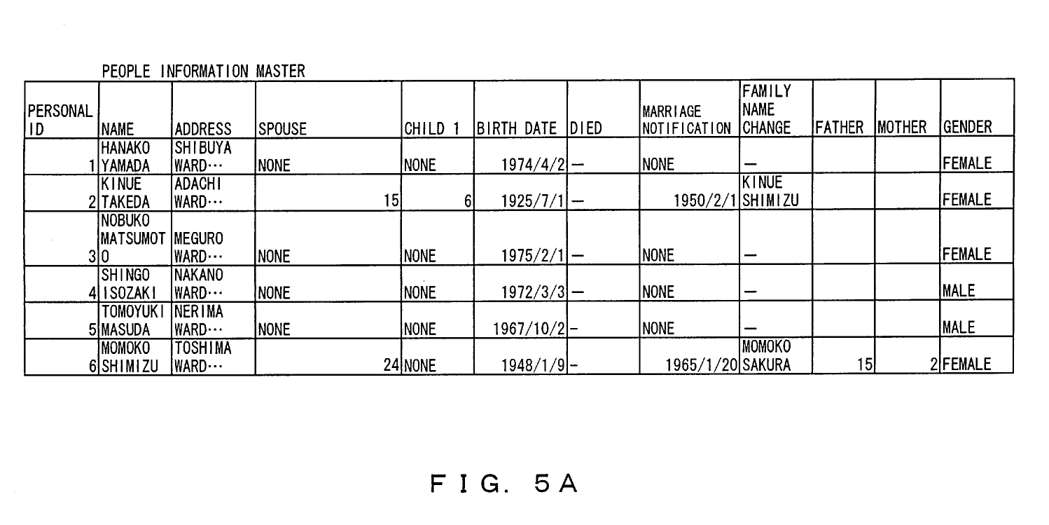

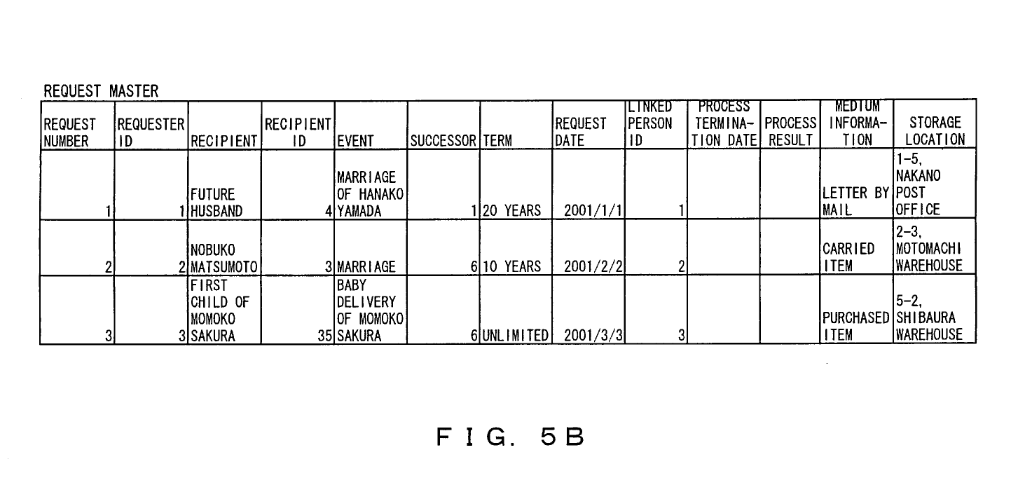

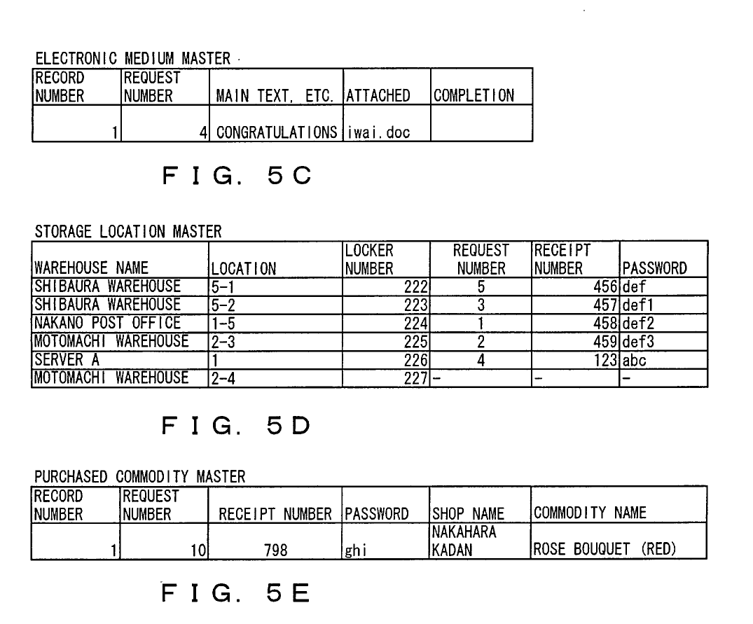

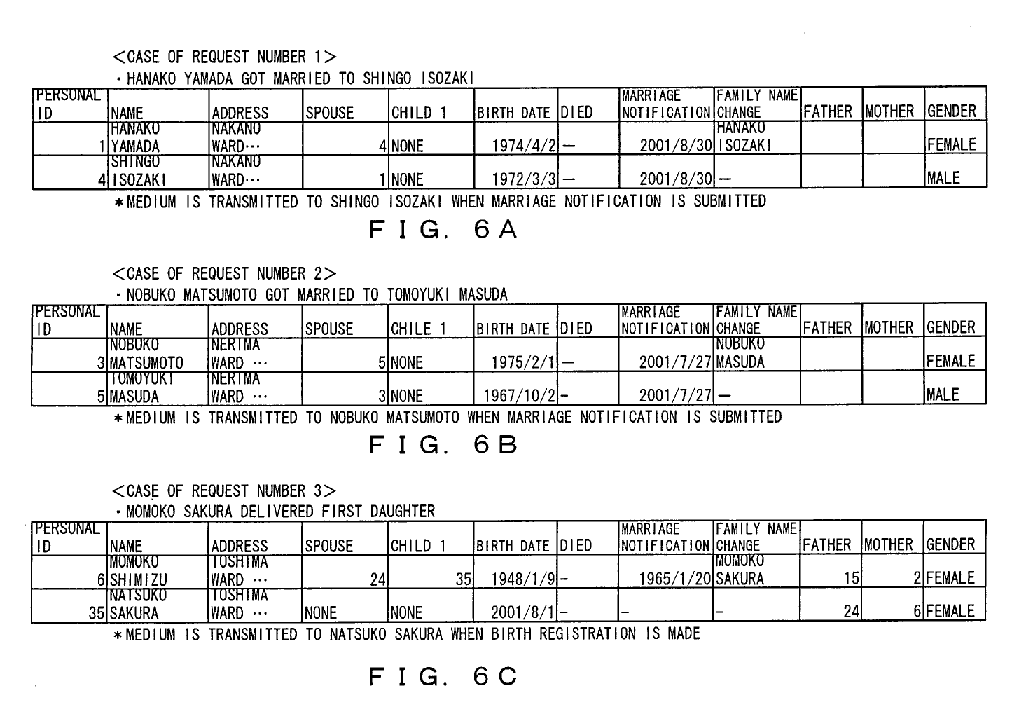

FIGS. 2A to 4 are flowcharts explaining the flows of processes according to the preferred embodiment of the present invention. FIGS. 5A to 5E exemplify data tables used in the processes according to this preferred embodiment, whereas FIGS. 6A to 6C exemplify data tables for explaining specific processes.

FIG. 2A shows a flow of a request process.

Firstly, a post office accepts a request from a user (step S1). The request is accepted by identifying a requester, contents of an event, a transmission medium, etc. For example, if the transmission medium is e-mail, an input of indicating that the medium to be transmitted is e-mail, contents of the e-mail to be transmitted, and an attached file if it exists are included in the contents of the request. If the transmission medium is a medium that is carried by a requester, the name of the carried medium, the date and time when the medium is carried, etc. are included in the contents of the request. The carried medium is appropriately held in a storage location by a service center such as a post office, etc. If the transmission medium is a commodity that is purchased online, the name of the online shop in which the commodity is purchased, the name of the purchased commodity, etc. are included in the contents of the request. Next, in step S2, the personal ID of the requester, the ID of a recipient, the personal ID of a successor, and the personal ID of a linked person are respectively obtained from the people information master possessed by the electronic government from the name and the address of the requester, the name and the address of the recipient, the name and the address of the successor, and the name and the address of the linked person, which are included in the contents of the request.

Here, a successor is a person who receives a medium instead of a requester if the requester is died or his whereabouts is unknown. Normally, however, a medium is returned to a requester if an event does not occur during an event specification term. Additionally, a linked person is a person who has a close relationship with a recipient, and becomes a key person for securely transmitting a medium to the recipient. Assume that a certain person delivered a baby. In this case, a linked person is a parent, etc. of the baby to whom a medium is transmitted. Namely, when the baby is born, the medium is transmitted to the baby based on the information of the linked person.

The people information master has, for example, a structure shown in FIG. 5A. Namely, name, address, presence/absence of a spouse, presence/absence of a child, birth date, date and time of death, date and time of marriage notification, name after family name change, father, mother, gender, e-mail address, etc. are registered for each personal ID.

People are obliged to register these items to the electronic government. However, a database including similar contents maybe generated under a condition that a private company keeps confidentiality of the database, and may be used in this preferred embodiment. Note that the information within the people information master can be obtained also from existing resident information or family register information.

Next, in step S3, a request number that is automatically assigned to a request, the personal ID of the requester, the personal ID of the successor, the personal ID of a linked person, a recipient name, the ID of the recipient, an event, a term, a request date, and medium information are registered to the request master. An electronic medium master is a master used to register the contents of a request if a transmission medium is e-mail. The request number, contents of main text, etc., and an attached file if it exists are registered to the electronic medium master. A storage location master is a master used when a transmission medium is an object carried by a requester. A warehouse name, a location within the warehouse, a locker number, a request number, a receipt number of the carried object, a password, etc. are registered to the storage location master. Furthermore, a purchased commodity master is a master used when a requester purchases a medium online. A request number, a receipt number, a password, a shop name, a commodity name, etc. are registered to the purchased commodity master.

The request master includes the information shown in FIG. 5B. Namely, a request number is assigned to each request, and a requester ID, a recipient name, a recipient ID, an event, a successor (identified with a personal ID), a term, a request date, a linked person ID, a process termination date, a process result, medium information, etc. are included for each request.

Here, the term is a time period during which a transmission service must be rendered when a specified event occurs. Accordingly, even if a specified event occurs, a transmission service is not rendered if the occurrence of the event is not within the specified term. Additionally, the medium information describes an object that a requester desires to transmit.

To the electronic medium master, a request number, the main text of e-mail to be transmitted, which is specified by a request identified with the request number, and an attached file if it exists are registered in correspondence with a record number assigned to each entry. Each entry includes also a field for registering a completion mark when the execution of a request is verified to be completed.

The storage location master is a master for a location in which a carried medium is held when a requester carries the medium as shown in FIG. 5D. A location within a warehouse and a locker number are indicated for each warehouse name, and a request number and the receipt number of the medium held in the location identified with the above described information, and a password are registered.

Furthermore, the purchased commodity master is a master used when a requester purchases a medium online as shown in FIG. 5E. To the purchased commodity master, a request number, a receipt number, a password, a shop name, and a commodity name are registered in correspondence with a record number.

Then, in step S4, a request number is assigned to the transmission medium (object to be transmitted), and the request process is terminated.

FIG. 2B is a flowchart showing the flow of a request deletion process.

Firstly, instep S10, a user accesses a post office via a network, and inputs his or her personal ID. In step S11, a record in which a requester ID matches the input personal ID is displayed from the request master among records in which a request termination date is not input. In step S12, the user selects a request number that he or she desires to delete from among displayed records, and requests a deletion after selecting whether or not to require a medium to be returned. In step S13, the server of the post office deletes the record of the selected request number from the request master. Or, a cancel flag may be attached to a record. Then, in step S14, the post office side extracts the address and the name from the people information master according to the personal ID if the medium is required to be returned, and returns the medium to the extracted name at the extracted address. If the medium is not required to be returned, the post office side destroys the medium.

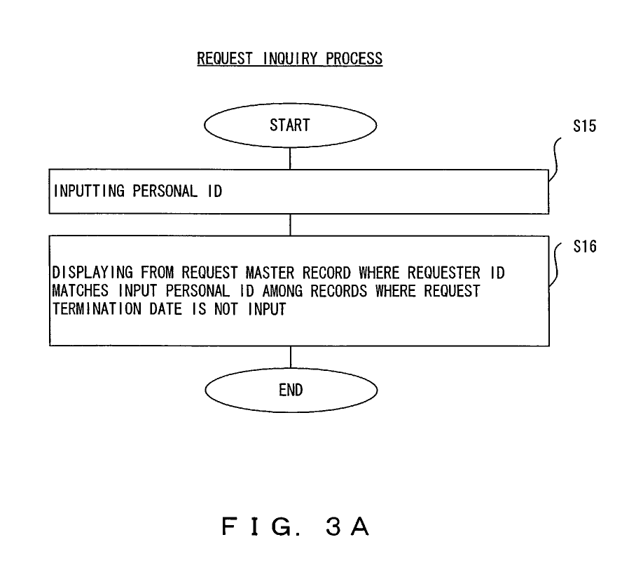

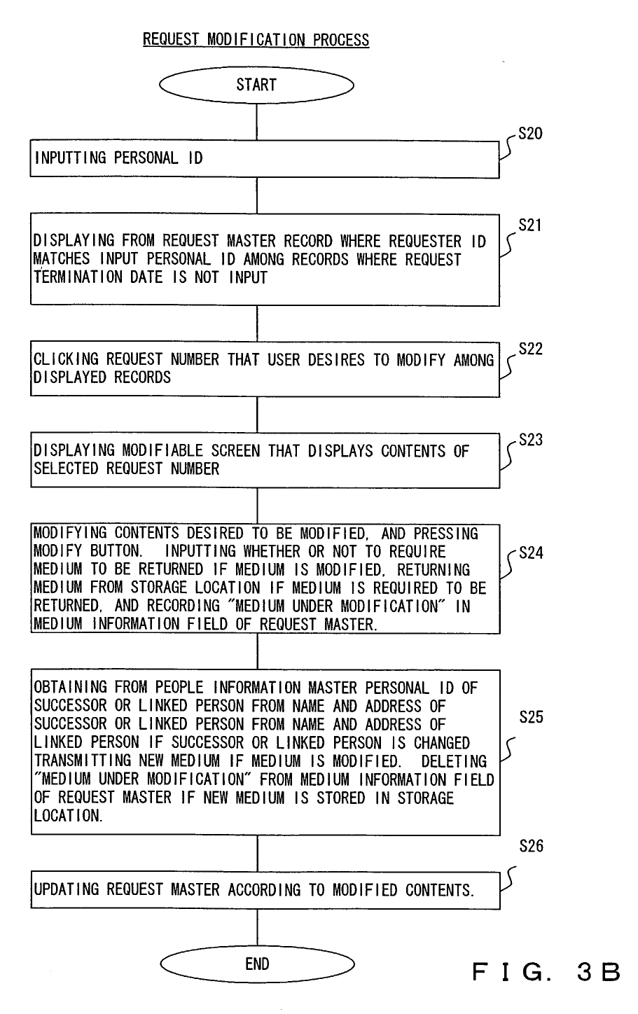

FIG. 3A is a flowchart showing the flow of a request inquiry process.

Firstly, a user connects his or her terminal to a network, and accesses a server of a post office. Then, in step S15, the user inputs his or her personal ID. In step S16, the server of the post office displays from the request master a record in which a request ID matches the input personal ID among records in which a request termination date is not input. Here, the process is terminated.

FIG. 3B is a flowchart showing the flow of a request modification process.

Firstly, a user connects his or her terminal to a network, and accesses a server of a post office. Then, in step S20, the user inputs his or her personal ID from the terminal. In step S21, the server of the post office displays from the request master a record in which a requester ID matches the input personal ID among records in which a request termination date is not input. In step S22, the user selects a request number that the user desires to modify from among displayed records. In step S23, the server of the post office displays a modifiable screen which displays the contents of the selected request number. In step S24, the user modifies the contents that the user desires to modify by using the modifiable screen, and determines the modification. Here, if a medium (object to be transmitted), especially, actual stuff to be transmitted is changed, the user must actually goes to the post office and replaces the medium in addition to an operation for modifying the record on the modifiable screen. In step S25, if a successor or a linked person is changed, the server of the post office respectively obtains the personal ID of the successor, and the personal ID of the linked person from the people information master according to the name and the address of the successor, and the name and the address of the linked person. Then, in step S26, the server of the post office updates the request master based on the modified contents. Here, the process is terminated.

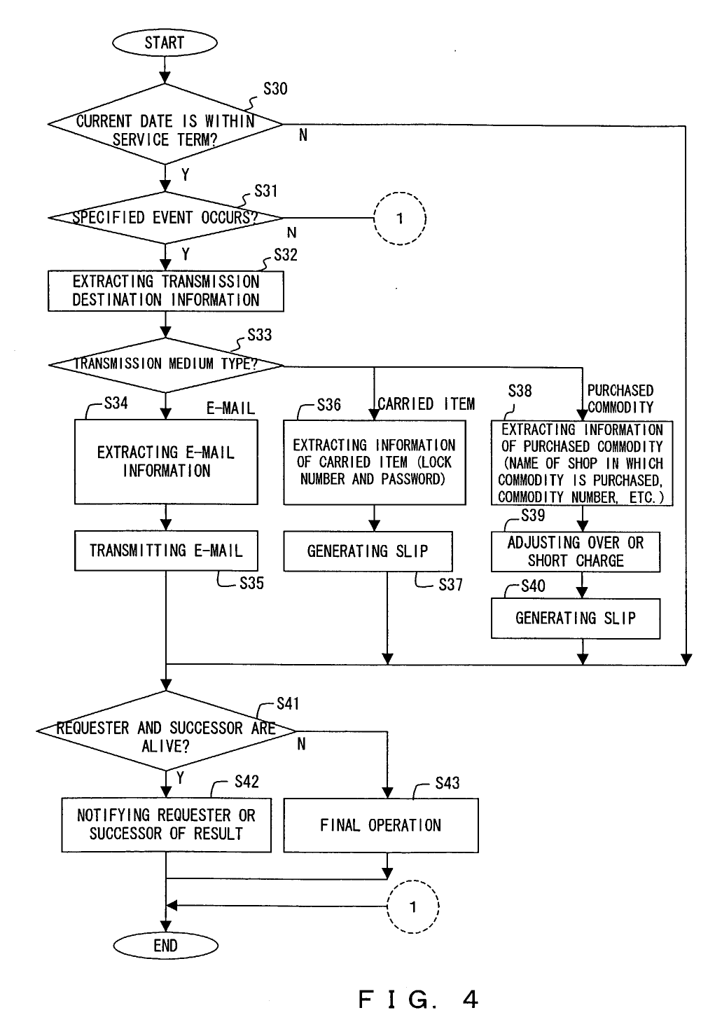

FIG. 4 is a flowchart showing the flow of a process (batch process) that a server of a post office periodically performs.

The server of the post office determines whether or not a current date is within a service term in steo S30. If the current date is not within the service term as a result of the determination made in step S30, the process proceeds to step s41. If the current date is within the service term as a result of the determination made in step S30, it is further determined whether or not a specified event occurs in step S31. If the event does not occur, the process is terminated.

If the event is determined to occur in step S31, the process proceeds to step S32, and the transmission destination information of the medium is extracted. In step S33, the type of the medium to be transmitted is determined. This determination is made by referencing the medium information within the request master shown in FIG. 5B with the use of the request number as a key. If the medium is determined to be e-mail, mail information is extracted by referencing the electronic medium master shown in FIG. 5C in step S34, so that main text and an attached file are extracted, and completion identification information is set in a completion field. Then, in step S35, the e-mail is transmitted to the transmission destination, and the process proceeds to step S41.

If the medium is determined to be a carried item in step S33, the storage location master shown in FIG. 5D is referenced, and information of the carried item (warehouse name, location, locker number, password, etc.) are extracted by using the request number as a key in step S36. Then, a slip is generated in step S37.

If the medium is determined to be a purchased commodity in step S33, the purchased commodity master shown in FIG. 5E is referenced, and information of the purchased commodity (the name of the shop in which the commodity is purchased, the name of the commodity, the receipt number, etc.) are extracted according to the request number in step S38. Then, in step S39, an over or short charge is adjusted in step S39, and a slip is generated in step S40. Here, a purchased commodity is an item that is purchased when a requester uses a commodity purchase service rendered as part of the service, and directly transmits a commodity purchased via a network to a recipient.

In step S41, it is determined whether or not the requester and the successor are alive. If the result of the determination made in step S41 is “YES”, the process proceeds to step S42 where a result is notified to the requester or the successor. Here, the process is terminated. If the result of the determination made in step S41 is “NO”, the final operation is performed in step S43, and the process is terminated. Here, the final operation corresponds to the case where the requester and the successor are not alive, and it is an operation for transmitting the completion notification of the service to a relative, etc. of the requester or the successor.

Operations according to specific examples of the preferred embodiment of the present invention are described with reference to FIGS. 5A to 5E, and FIGS. 6A to 6C.

Firstly, as shown in FIG. 6A, the people information master is searched according to the ID of a linked person if the process for a request number 1 shown in FIG. 5B is performed. As a result, people information of Hanako Yamada having a personal ID 1 is obtained. Here, if a date is written to the marriage notification field, a medium is transmitted by recognizing that the event of the request number 1 has occurred. Here, although the spouse of Hanako Yamada is specified as a transmission destination, the ID of the spouse is proved to be 4 according to the people information of Hanako Yamada. Therefore, the medium is transmitted to Shingo Isozaki having a personal ID 4.

In case of a request number 2 shown in FIG. 5B, marriage is specified as an event as shown in FIG. 6B. Therefore, people information is obtained according to the ID of Nobuko Matsumoto, who is a recipient. When a marriage notification is submitted, a medium is transmitted to Nobuko Matumoto.

In case of a request number 3 shown in FIG. 5B, baby delivery of Momoko Sakura is specified as an event as shown in FIG. 6C. Therefore, the server of the post office monitors the record of Momoko Sakura within the people information master. When information is newly set in a child field, an ID of the child is obtained, and a medium is transmitted to Natsuko Sakura, who is a child of Momoko Sakura (former name: Momoko Shimizu). Since the ID of mother of Natsuko Sakura having a personal ID 35 is 6 in this case as shown in FIG. 6B, the child of Momoko Sakura is proved to be Natsuko Sakura. In this case, a recipient is a newborn baby. Therefore, the ID of a linked person is obtained, and the data of Momoko Sakura who has the personal ID 6 and is the mother within the people information master is obtained, the child of Momoko Sakura is detected to be Natsuko Sakura, the transmission destination is obtained from the record of Natsuko Sakura, and the medium is transmitted to Natsuko Sakura. Also for a second or subsequent child, a similar process is performed.

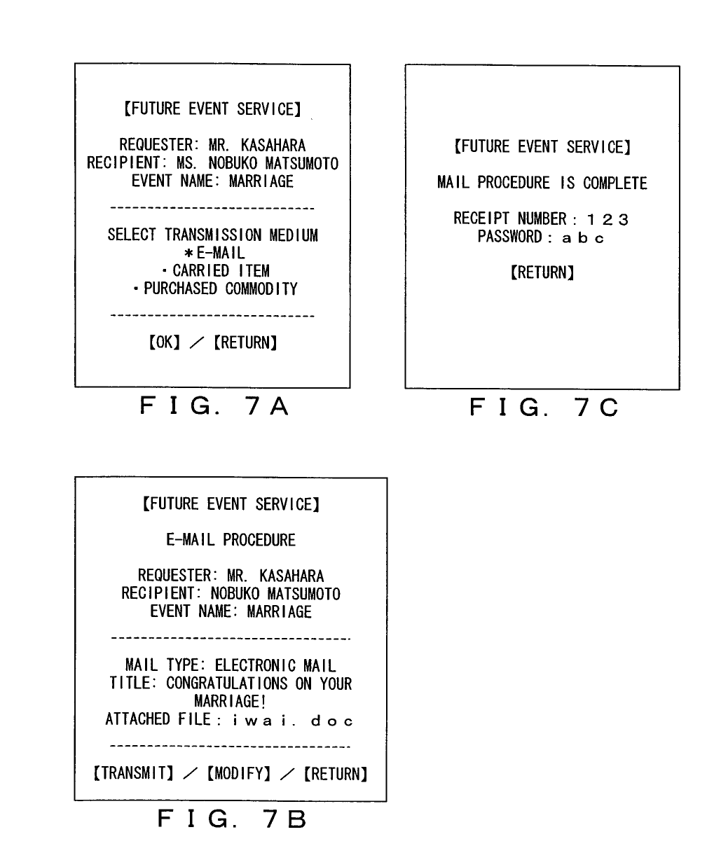

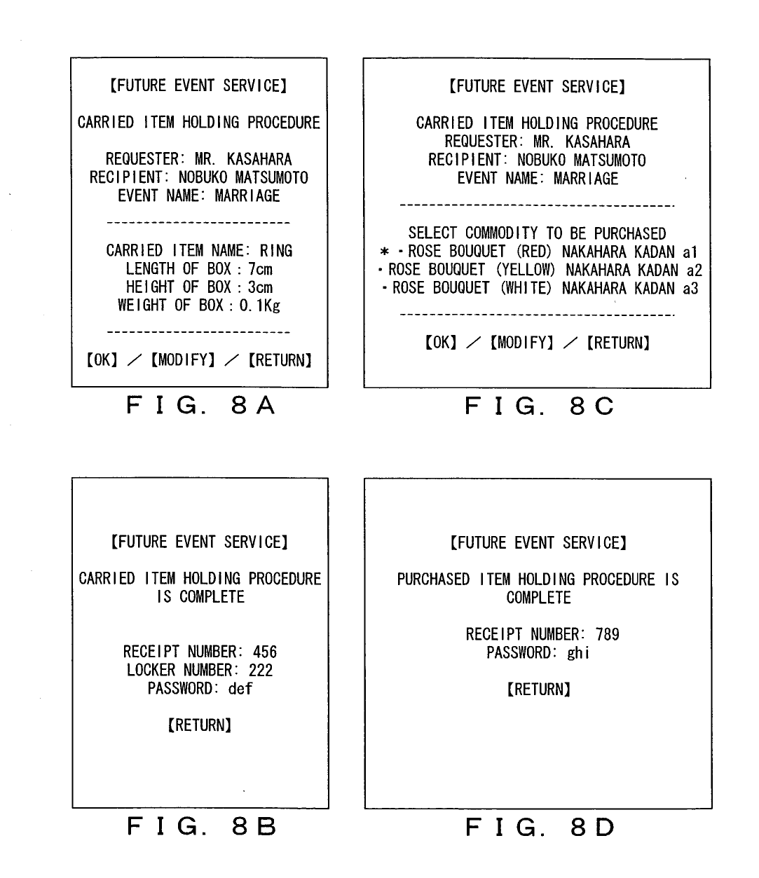

FIGS. 7A to 7C and 8A to 8D exemplify displays according to the preferred embodiment of the present invention.

Firstly, if a user accesses the server in this preferred embodiment via a network in order to receive the service according to the preferred embodiment of the present invention, information of the user being a requester is input. Then, a screen shown in FIG. 7A, which is a screen for selecting a transmission medium, is displayed.

On the screen shown in FIG. 7A, a requester, a recipient, and an event name are displayed, and at the same time, options of a transmission medium are displayed. In this case, (electronic) mail, a carried item, and a purchased commodity are displayed. Here, if the mail is selected, electronic mail is displayed as a mail type as shown in FIG. 7B. The requester writes the title of the electronic mail, and specifies a file to be attached. Here, a file named iwai.doc is attached.

Then, the requester presses a transmit button, so that completion of the mail procedure, the receipt number of the service, and a password for accessing the information of the service are displayed, and the process is terminated.

If the medium is a carried item, a screen shown in FIG. 8A is displayed. On this screen, a requester, a recipient, and an event name are displayed, and at the same time, the name of a carried item, and the length, the height, and the weight of a box, which are input by the requester, are displayed. Then, the requester presses an OK button, so that completion of the procedure for holding the carried item, the receipt number of the service, a locker number, and a password are displayed as shown in FIG. 8B.

If the medium is a purchased commodity, a display shown in FIG. 8C is made. Namely, a requester, a recipient, an event name, and options of a purchased commodity are displayed. Here, only a rose bouquet (red), a rose bouquet (yellow), and a rose bouquet (white) are exhibited as purchased commodities. However, these are one example, and actually, all of purchased item that the service providing side can accept are listed. The requester selects a commodity to be purchased, and presses the OK button, so that completion of the procedure for holding the purchased commodity, a receipt number, and a password are displayed as shown in FIG. 8D, and the process is terminated.

Note that the people information can be obtained also from existing resident information or family register information.

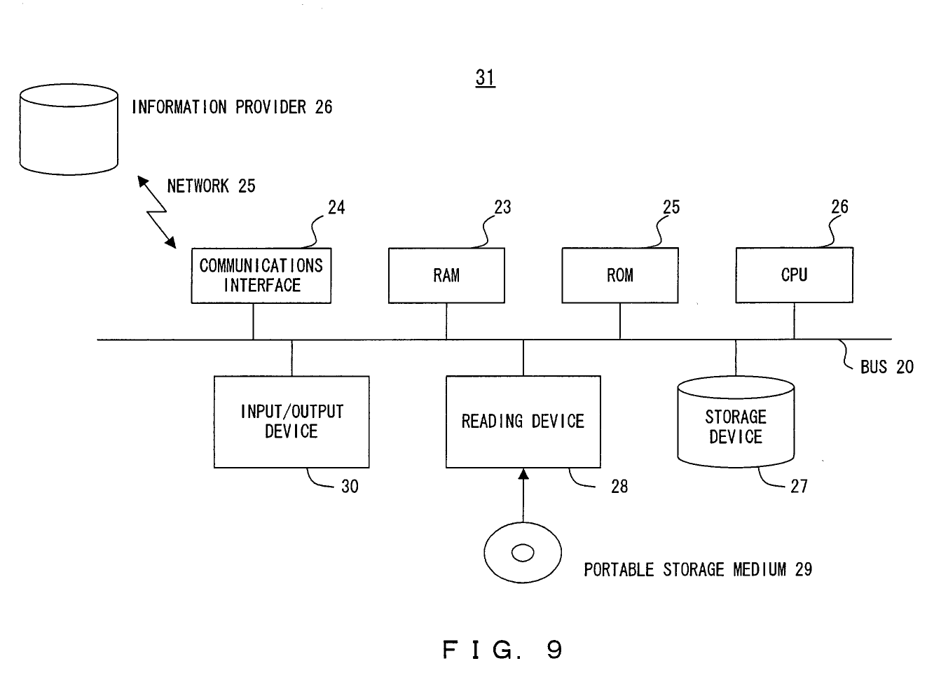

FIG. 9 shows the hardware environment required when the preferred embodiment according to the present invention is implemented with a program.

An information processing device 31 is considered to be used as a server of a service center such as a post office, etc. The information processing device 31 comprises a CPU 21, copies the program stored in a storage device 27 such as a hard disk, etc. to a RAM 23 via a bus 20, and executes the program. Basic programs such as BIOS, etc. are stored in a ROM 22. However, the program may be stored in the ROM 22, and the CPU 2 may execute the program.

A reading device 28 can be used to install the program in the information processing device 31 by reading the program from a portable storage medium 29 such as a flexible disk, a CD-ROM, a DVD, an MO, etc., and by storing the program in the storage device 27 via the bus 20. Or, the program may be directly read from the portable storage medium 29, and the CPU 21 may execute the program.

An input/output device 30 is composed of a keyboard, a mouse, a template, a display, etc., and is used to input a command to the CPU 21 by a server administrator, or to present a computation result of the CPU 21 to the server administrator.

A communications interface 24 connects the information processing device 31 to a network 25, and accesses an information provider 26 via the network 25. The information processing device 31 may download the program from the information provider 26, and install and execute the program.

Or, the information provider 26 may execute the program without downloading and installing the program, and the information processing device 31 may receive the result of the execution.

According to the present invention, rendering of a service such as a medium transmission to a corresponding person can be reserved for a future event which occurs for the person, and the service can be expanded.

Especially, when mail is used, a transmission procedure can be performed beforehand by assuming that an event occurs, even if a recipient has not determined yet.

What is claimed is:

1. A future event service rendering method, comprising:
receiving from a user identification information of an event, a date and time when the event occurs, information of a medium transmitted when the event occurs, and transmission destination information of the medium; and
extracting information of whereabouts of a person who is associated with the event, when an occurrence of the event received from the user is detected based on a first storing unit storing the identification information of the event, the date and time when the event occurs, and the information of whereabouts of the person who is associated with the event, and a second storing unit storing the information received from the user.

2. A future event service rendering apparatus, comprising:
a first storing unit storing identification information of an event, a date and time when the event occurs, and information of whereabouts of a person who is associated with the event;
a second storing unit storing the identification information of the event, the date and time when the event occurs, information of a medium to be transmitted when the event occurs, and transmission destination information of the medium, which are received from a user;
a unit receiving the information which are received from the user and stored in said second storing unit; and
a unit extracting the information of whereabouts of the person who is associated with the event, when an occurrence of the event received from the user is detected based on said first storing unit and said second storing unit.

3. A program for causing a computer to execute a process, the process comprising:
receiving from a user identification information of an event, a date and time when the event occurs, information of a medium transmitted when the event occurs, and transmission destination information of the medium; and
extracting information of whereabouts of a person who is associated with the event, when an occurrence of the event received from the user is detected based on a first storing unit storing the identification information of the event, the date and time when the event occurs, and the information of whereabouts of the person who is associated with the event, and a second storing unit storing the information received from the user.

4. A computer-readable storage medium on which is recorded a program for causing a computer to execute a process, the process comprising:
receiving from a user identification information of an event, a date and time when the event occurs, information of a medium transmitted when the event occurs, and transmission destination information of the medium; and
extracting information of whereabouts of a person who is associated with the event, when an occurrence of the event received from the user is detected based on a first storing unit storing the identification information of the event, the date and time when the event occurs, and the information of whereabouts of the person who is associated with the event, and a second storing unit storing the information received from the user.

5. A future event service rendering method, comprising:
receiving from a user identification information of an event, a date and time when the event occurs, information of e-mail transmitted when the event occurs, and transmission destination information of the e-mail; and
extracting e-mail transmission destination of a person who is associated with the event, and the information of the e-mail, when an occurrence of the event received from the user is detected based on a people information master storing the identification information of the event, the date and time when the event occurs, and information of whereabouts of the person who is associated with the event, a request master storing the information received from the user, and an electronic medium master storing the information of the mail.

6. The future event service rendering method according to claim 5, wherein
the information of the e-mail has an attached file.

7. A future event service rendering method, comprising:
receiving from a user identification information of an event, a date and time when the event occurs, information of a carried item to be transmitted when the event occurs, and transmission destination information of the carried item; and
extracting information of whereabouts of a person who is associated with the event, and the information of the carried item, when an occurrence of the event received from the user is detected based on a people information master storing the identification information of the event, the date and time when the event occurs, and the information of whereabouts of the person who is associated with the event, a request master storing the information received from the user, and a storage location master storing a location in which the carried item is held.

8. A future event service rendering method, comprising:
receiving from a user identification information of an event, a date and time when the event occurs, information of a carried item to be transmitted when the event occurs, and transmission destination information of the carried item;
extracting information of whereabouts of a person who is associated width the event, and the information of the carried item when an occurrence of the event received from the user is detected based on a people information master storing the identification information of the event, the date and time when the event occurs, and the information of whereabouts of the person who is associated with the event, a request master storing the information received from the user, and a storage location master storing a location in which the carried item is held; and
generating a slip for delivering the carried item based on the people information master, the request master, and the storage location master.

9. A future event service rendering method, comprising:
receiving from a user identification information of an event, a date and time when the event occurs, information of a purchased commodity to be transmitted when the event occurs, and transmission destination information of the purchased commodity; and
extracting information of whereabouts of a person who is associated with the event, and the information of the purchased commodity, when an occurrence of the event received from the user is detected based on a people information master storing the identification information of the event, the date and time when the event occurs, and the information of whereabouts of the person who is associated with the event.

10. A future event service rendering method, comprising:
receiving from a user identification information of an event, a date and time when the event occurs, information of a purchased commodity to be transmitted when the event occurs, and transmission destination information of the purchased commodity;
extracting information of whereabouts of a person who is associated with the event, and the information of the purchased commodity, when an occurrence of the event received from the user is detected based on a people information master storing the identification information of the event, the date and time when the event occurs, and the information of whereabouts of the person who is associated with the event, a request master storing the information received from the user, and a purchased commodity master storing the identification information of the purchased commodity; and
generating a slip for delivering the purchased commodity based on the people information master, the request master, and the purchased commodity master.
